(19) United States
(12) Patent Application Publication
(10) Pub. No.: US 2005/0189177 A1
(43) Pub. Date: Sep. 1, 2005

(54) Descent apparatus

(76) Inventor: Ronan Anthony Byrne, Middlesex (GB)

Correspondence Address: BROOKS KUSHMAN P.C., 1000 TOWN CENTER, TWENTY-SECOND FLOOR, SOUTHFIELD, MI, 48075, US

(21) Appl. No.: 10/505,541

(22) PCT Filed: Jan. 27, 2003
(86) PCT No.: PCT/GB03/00340

§ 371 Date: Aug. 23, 2004

(30) Foreign Application Priority Data
Feb. 25, 2002 (GB) 0204347.9

(51) Int. Cl. A62B 1/10

(52) U.S. Cl. 182/239

(57) ABSTRACT

A portable descent apparatus (1) for use in effecting the controlled descent of a body from an elevated location, for example a multi-storey building, comprises in combination a support frame (2) having a substantially planar base (3) and upright supporting end brackets (4,5), a fixed shaft (6) extending between said end brackets, a rotatable drum (7) coaxially mounted on said shaft and having means for attachment of one end of a flexible cable (17) thereto, the drum (7) having fixed to one end thereof a manually or remotely controllable calliper-operated disc brake assembly and to the other end thereof a gear driven descent speed controller comprising a toothed annular member (13) meshing with a pinion (19) driving a centrifugal brake assembly (12), the flexible cable (17) having one end attached to said drum and the other end (16) thereof having anchoring means for attaching the cable to a fixed position (18), and a first handle means (15) attached to the support frame (2) adjacent to said disc brake assembly and provided with means (11) for manually or remotely controlling the braking effect of the disc brake assembly, and a second handle means (14) attached to the support frame (2) adjacent to said descent speed controller, the arrangement being such that in use the apparatus may be held using the two handle means (14,15) with the planar base (3) positioned against the descending body.

This invention relates to a portable descent apparatus for use in effecting a controlled descent from an elevated location, for example a multi-storey building, an airborne helicopter, a steep cliff face or a cable car.

The increase in the number of tall buildings being built throughout the world has made it necessary to consider what means can be used to rescue persons trapped on the upper floors of high-rise buildings in the case of a fire or other emergency, when it is not possible to make use of the normal means of leaving a building. The catastrophic consequences of the terrorist attack on the World Trade Centre buildings in New York on 11 Sep. 2001 has given added impetus to the necessity of devising a portable descent apparatus which could be used by individuals to escape from a tall building when the normal exit means or escape means are unusable. Such descent apparatus must be sufficiently compact to be easily storable until required for use and sufficiently lightweight and simple for ease of use in an emergency.

Several forms of emergency descent devices for lowering a person from a high-rise building have hitherto been proposed, but they have had the disadvantage that they generally require the use of a strap, belt or sling suspended some distance from the device, which makes it more difficult to control the descent especially when windy conditions are encountered.

It is therefore an object of the present invention to provide a portable descent apparatus for use in effecting a controlled descent from an elevated location, such as when escaping from a multi-storey building which will avoid the use of such a strap or sling or the like suspended from the device and hence avoid the disadvantage of the prior descent devices, and which will be sufficiently compact for ease of use and storage.

According to the invention, there is provided a portable descent apparatus for use in effecting the controlled descent of a body from an elevated location, the apparatus comprising in combination a support frame having a substantially planar base and upright supporting end brackets, a fixed shaft extending between said end brackets, a rotatable drum coaxially mounted on said shaft and having means for attachment of one end of a flexible cable thereto, the drum having fixed to one end thereof a manually or remotely controllable calliper-operated disc brake assembly and to the other end thereof a gear driven descent speed controller comprising a toothed annular member meshing with a pinion driving a centrifugal brake assembly, the flexible cable having one end attached to said drum and the other end thereof having anchoring means for attaching the cable to a fixed position, and a first handle means attached to said support frame adjacent to said disc brake assembly and provided with means for manually or remotely controlling the braking effect of the disc brake assembly, and a second handle means attached to said support frame adjacent to said descent speed controller, the arrangement being such that in use the apparatus can be held using the two handle means with said planar base positioned against the descending body.

In the descent speed controller the toothed annular member meshes with a pinion driving the centrifugal brake assembly so as to control the rotational speed of the centrifugal brake, which in turn controls the rate of descent.

When the descent apparatus is to be used by humans rather than inanimate bodies, it is advantageous for a harness to be worn by the person using the apparatus to assist in maintaining the apparatus in position against the person's chest. For this purpose, the support frame will be provided with a plurality of attachment points for the harness.

The cable attached to the drum of the apparatus can be made from any suitable material, for example high tensile strength galvanised steel or stainless steel, and will be of a length and diameter appropriate to the height of the location from which descent is required. The diameter may be in the range of, for example from 2.5 to 4 mm.

Some or all of the components of the apparatus may be formed from a suitable lightweight material, for example an aluminium alloy, in order for the apparatus to be sufficiently portable when required for use.

For a better understanding of the invention and to show how the same may be carried into effect, reference will now be made, by way of example, to the accompanying drawings, in which:

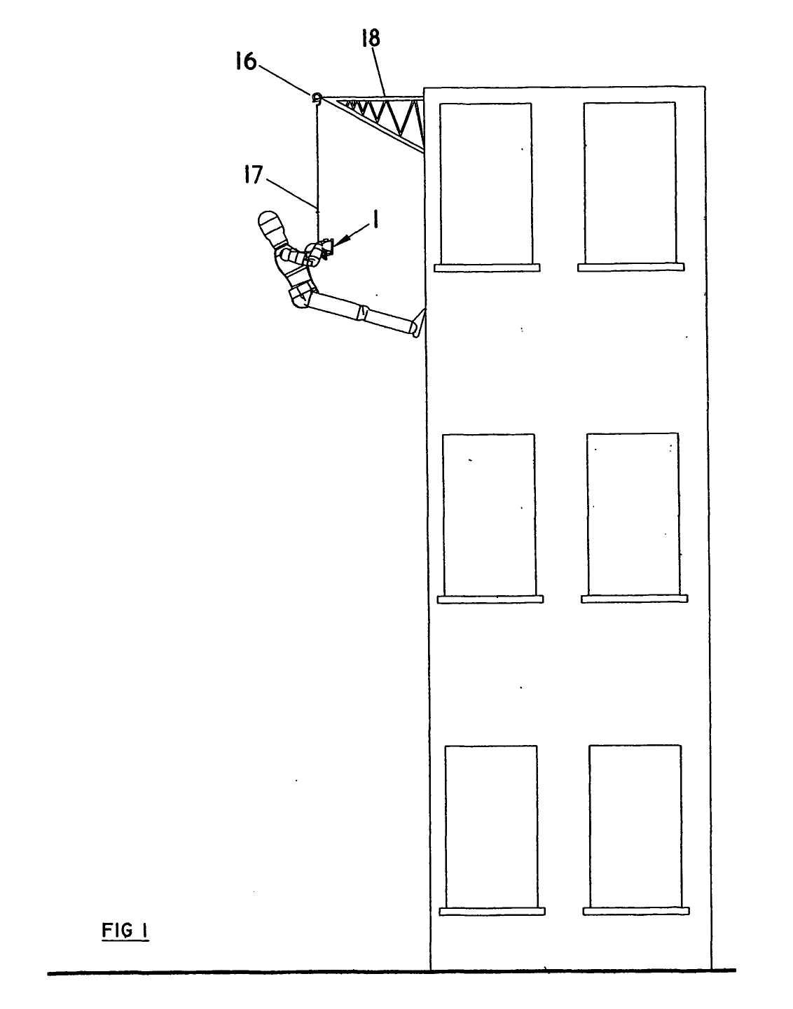

FIG. 1 is a side view showing a descent apparatus in use;

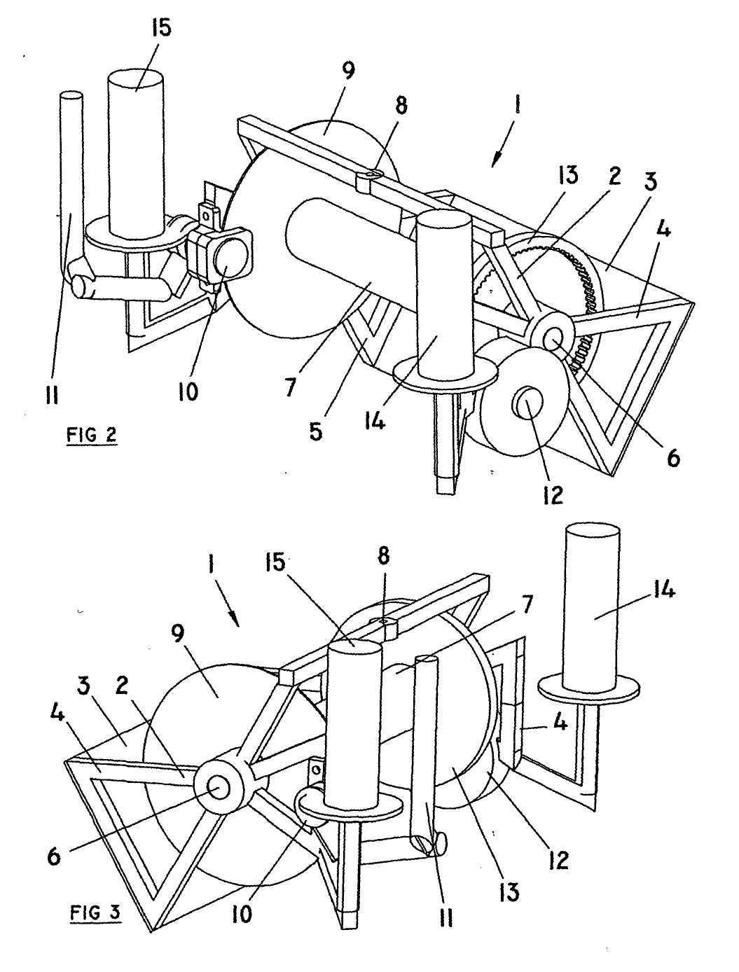

FIG. 2 is a perspective view from the left of the descent apparatus;

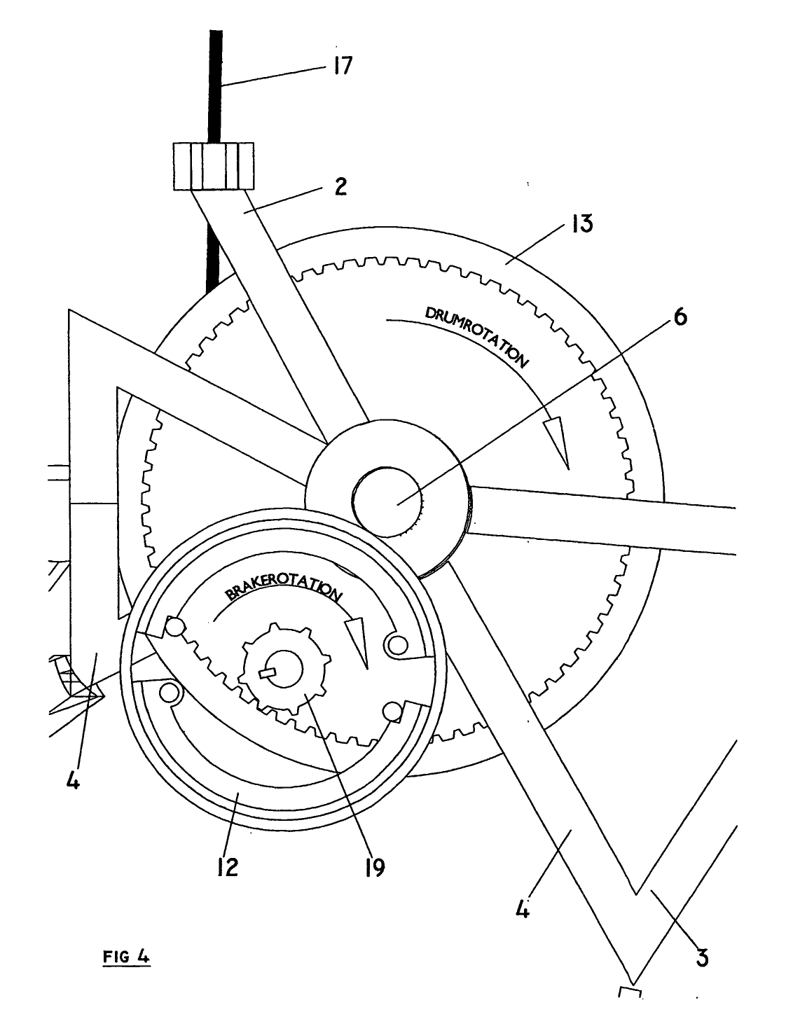

FIG. 3 is a perspective view of the descent apparatus from the right;

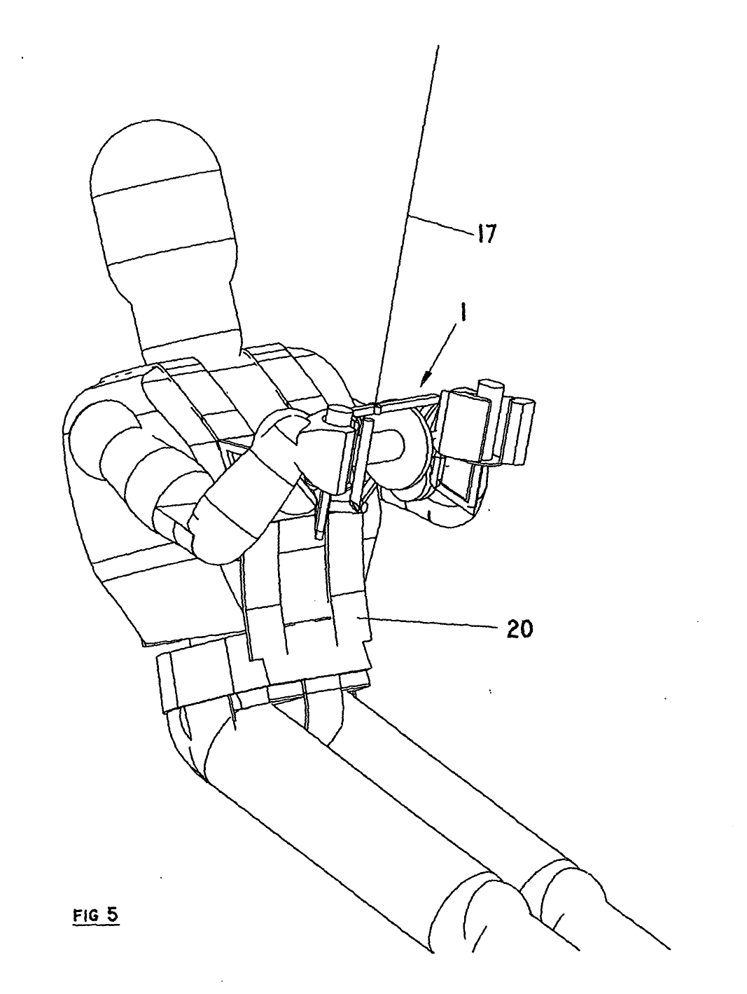

FIG. 4 is view from the left of the apparatus on an enlarged scale; and

FIG. 5 is a perspective view showing the descent apparatus in use with a harness.

Referring to the drawings, a personal descent apparatus 1 has a support frame 2 having a planar base 3, each end of which has an upright supporting bracket 4,5 respectively. A fixed shaft 6 extends between the end brackets 4,5 and a rotatable drum 7 is coaxially mounted on the shaft 6. The frame 2 is formed with a cylindrical aperture 8 which serves as an exit centering device for a cable 17 which can be fixed to the drum 7. To the right-hand end of the drum 7 is fixed a disc-brake assembly comprising a disc 9 and a manually-controllable pair of opposed brake pads 10, which can be operated by means of a brake lever 11.

At the left-hand end of the drum 7 is located a centrifugal brake 12 which is connected to an internally toothed ring gear 13 via a pinion 19 the gear ratio of which is designed to produce in use the desired controlled speed of descent. The apparatus 1 is provided with two hand grips 14, 15 which can be held by the descending person when the apparatus is used, as shown in FIGS. 1 and 5 of the drawings.

As will be apparent from FIGS. 1 and 5 of the drawings, in use the apparatus is held against the chest of the descending person using the two hand grips 14, 15 after the free end 16 of the cable 17 has been secured to a support 18 on the building, a harness 20 being worn to ensure that the apparatus maintains its position during descent.

1. A portable descent apparatus for use in effecting the controlled descent of a body from an elevated location, characterized in that the apparatus comprises in combination a support frame having a substantially planar base and upright supporting end brackets, a fixed shaft extending between said end brackets, a rotatable drum coaxially mounted on said shaft and having means for attachment of one end of a flexible cable thereto, the drum having fixed to one end thereof a manually or remotely controllable calliper-operated disc brake assembly and to the other end thereof a gear driven descent speed controller comprising a toothed annular member meshing with a pinion driving a centrifugal brake assembly, the flexible cable having one end attached to said drum and the other end thereof having anchoring means for attaching the cable to a fixed position, and a first handle means attached to the support frame adjacent to said disc brake assembly and provided with means for manually or remotely controlling the braking effect of the disc brake assembly, and a second handle means attached to the support frame adjacent to said descent speed controller, the arrangement being such that in use the apparatus can be held using the two handle means with the planar base positioned against the descending body.

2. A decent apparatus as claimed in claim 1, wherein the support frame is provided with a plurality of attachment points for a harness.

3. A descent apparatus as claimed in claim 1, wherein the cable is formed from high tensile strength galvanised steel or stainless steel, and has a diameter in the range from 2.5 to 4 mm.

4. A descent apparatus as claimed in claim 2, wherein the cable is formed from high tensile strength galvanised steel or stainless steel, and has a diameter in the range from 2.5 to 4 mm.
